(19) United States
(12) Patent Application Publication
(10) Pub. No.: US 2011/0148338 A1
(43) Pub. Date: Jun. 23, 2011

(54) ENERGY SAVING ELECTRONIC DEVICE, HEAT DISSIPATING FAN POWER CONTROL SYSTEM AND CONTROL METHOD THEREOF

(75) Inventor: Hsiang Jui LIN, Taipei (TW)

(73) Assignee: ELITEGROUP COMPUTER SYSTEMS CO., LTD., TAIPEI (TW)

(21) Appl. No.: 12/824,936

(22) Filed: Jun. 28, 2010

(30) Foreign Application Priority Data
Dec. 18, 2009 (TW) 098143793

(51) Int. Cl. H02P 7/292

(52) U.S. Cl. 318/500

(57) ABSTRACT

The present invention relates to energy saving electronic device, a heat dissipating fan power control system and a control method thereof. The heat dissipating fan power control system comprises a voltage selection circuit and a voltage conversion circuit. A plurality of voltage signals from a plurality power input terminals and a control are received by the voltage selection circuit to select one of the voltage signals as an output voltage signal. The voltage conversion circuit is connected to the voltage selection circuit to receive the output voltage signal and the control signal and to convert the voltage value of the output voltage into the work voltage value according to the control signal to thereby drive the heat dissipating fan.

### BACKGROUND OF THE INVENTION

1. Field of the Invention

The present invention relates to an energy saving electronic device, a heat dissipating fan power control system and a control method thereof. In particular, the present invention relates to an energy saving electronic device enabling highly efficient control over heat dissipating fans and decrement of voltage conversion loss for the purpose of energy saving and carbon reduction, and a heat dissipating fan power control system and control method thereof.

2. Description of Related Art

In currently available electronic devices, heat dissipating fans are mostly driven by the voltage signal of single voltage value directly supplied from the electronic device, keeping the heat dissipating fan being retained under an operation status of long-time high rotational speed, or alternatively the electronic device may use a control circuit to reduce the voltage signal to certain different voltage values so as to provide the required voltage for different rotational speeds of the heat dissipating fan.

However, suppose the heat dissipating fan is operating at a lower rotational speed which may simply consumes less voltage for driving, the control circuit needs to consume most of the power in a form of heat dissipation, thus it possibly causes potential over-heat problem in the control circuit and quite a few environmental protection issues due to such a way of heat dissipation resulting from unnecessary additional energy supply.

### SUMMARY OF THE INVENTION

In regards of the aforementioned drawbacks found in prior art, the objective of the present invention is to provide an energy saving electronic device, a heat dissipating fan power control system and a control method thereof thereby enabling resolutions to the potential over-heat problem in the control circuit as well as environmental protection issues concerning excessive energy consumption.

According to the objective of the present invention, a heat dissipating fan power control system is disclosed for providing a working voltage required by a heat dissipating fan, which has a working voltage value. The heat dissipating fan power control system comprises a voltage selection circuit and a voltage conversion circuit. The voltage selection circuit receives a plurality of voltage signals provided by a plurality of voltage input ends and a control signal, and selects one of the plurality of voltage signals according to the control signal as an output voltage signal. The voltage conversion circuit is connected to the voltage selection circuit, receiving the selected output voltage signal and the control signal, and converting the voltage value of the output voltage signal into the working voltage value according to the control signal, thereby driving the heat dissipating fan.

Herein, the output voltage signal may be selected from the plurality of voltage signals such that the voltage value thereof is greater than and closest to the working voltage value.

Furthermore, the present invention also discloses an energy saving electronic device, comprising a heat dissipating fan and a heat dissipating fan power control system. The heat dissipating fan power control system comprises a voltage selection circuit and a voltage conversion circuit. The voltage selection circuit receives a plurality of voltage signals provided by a plurality of voltage input ends and a control signal, and selects one of the plurality of voltage signals as an output voltage signal based on the control signal. The voltage conversion circuit is connected between the voltage selection circuit and the heat dissipating fan, and receives the output voltage signal and the control signal, and then converts 1 the voltage value of the output voltage signal into the working voltage value according the control signal, thereby driving the heat dissipating fan.

Herein, the output voltage signal may be selected from the plurality of voltage signals such that the voltage value thereof is greater than and closest to the working voltage value.

Additionally, the present invention further discloses a heat dissipating fan power control method for providing a working voltage required by a heat dissipating fan, which has a working voltage value. The heat dissipating fan power control method comprises the following steps: initially, receiving, through a voltage selection circuit, a plurality of voltage signals provided by a plurality of voltage input ends and a control signal; next, selecting, through the voltage selection circuit, one of the plurality of voltage signals as an output voltage signal based on the control signal; finally, receiving, through a voltage conversion circuit, the selected output voltage signal and the control signal, and converting the voltage value of the output voltage signal into the voltage value of the working voltage based on the control signal, thereby driving the heat dissipating fan.

Herein, the output voltage signal may be selected from the plurality of voltage signals such that the voltage value thereof is greater than and closest to the working voltage value.

In summary, the energy saving electronic device, the heat dissipating fan power control system and the control method thereof in accordance with the present invention can enable one or more of the following advantages:

(1) The energy saving electronic device, heat dissipating fan power control system and control method may be able to lessen unnecessary energy consumptions by means of choosing the voltage signal greater than but closest to the working voltage as the power source for driving the heat dissipating fan.

(2) The energy saving electronic device, heat dissipating fan power control system and control method may be able to reduce the temperature in the voltage conversion circuit by means of choosing the voltage signal greater than but closest to the working voltage as the power source for driving the heat dissipating fan.

### BRIEF DESCRIPTION OF THE DRAWINGS

FIG. 1 is a block diagram for a first embodiment of the heat dissipating fan power control system according to the present invention;

FIG. 2 is a block diagram for a second embodiment of the heat dissipating fan power control system according to the present invention;

FIG. 3 is a circuit diagram for the voltage selection circuit illustrated in the second embodiment of the heat dissipating fan power control system according to the present invention;

FIG. 4 is a block diagram for the energy saving electronic device according to the present invention; and

FIG. 5 is a flowchart for the heat dissipating fan power control method according to the present invention.

### DETAILED DESCRIPTION OF THE PREFERRED EMBODIMENTS

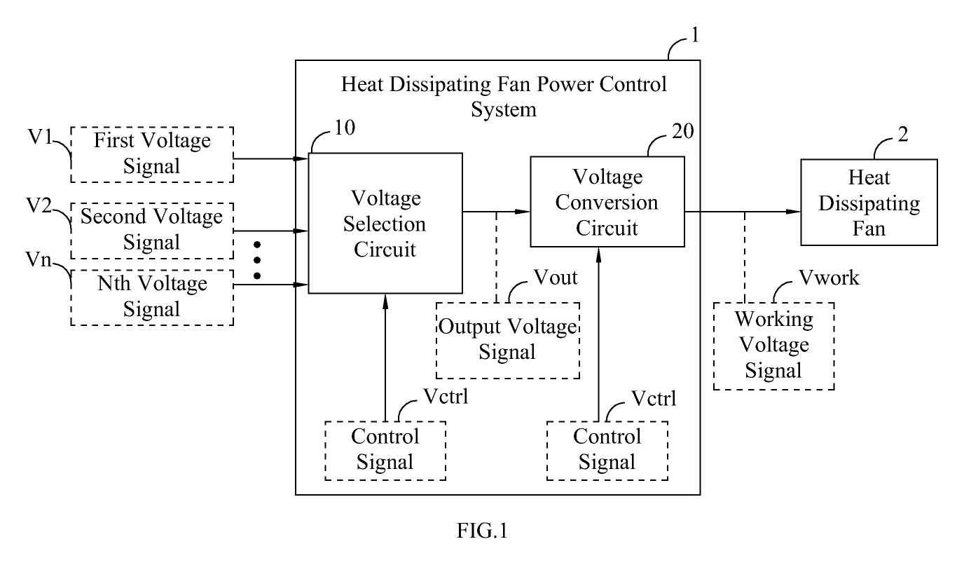

Refer first to FIG. 1, wherein a block diagram for a first embodiment of the heat dissipating fan power control system according to the present invention is shown. The heat dissipating fan power control system 1 can be applied to supply a heat dissipating fan 2 with the required working voltage. In the figure, the heat dissipating fan power control system 1 comprises a voltage selection circuit 10 and a voltage conversion circuit 20. The voltage selection circuit 10 receives a plurality of voltage signals and a control signal Vctrl, and selects one of the plurality of voltage signals as the output voltage signal Vout based on the control signal Vctrl. The output voltage signal Vout is selected from the plurality of voltage signals such that the voltage value thereof is greater than and closest to the working voltage value of the working voltage signal Vwork. In the present embodiment, the plurality of voltage signals are sequentially referred as the first voltage signal V1 to the Nth voltage signal Vn, with each voltage signal having a different voltage value.

The voltage conversion circuit 20 is connected to the voltage selection circuit 10 in order to receive the output voltage signal Vout and the control signal Vctrl, and converts the voltage value of the output voltage signal Vout into the voltage value of the working voltage signal Vwork based on the control signal Vctrl for driving the heat dissipating fan 2. The voltage conversion circuit 20 is preferably a voltage reduction circuit.

In the present embodiment, it is exemplary to take the voltage value of the first voltage signal V1 to be 3.3 Volt (V) and the voltage value of the second voltage signal V2 to be 5V. In case that the voltage value of the working voltage signal Vwork required by the heat dissipating fan 2 is 2.5V, the voltage selection circuit 10 selects the first voltage signal V1 as the output voltage signal Vout, and the voltage conversion circuit 20 reduces the 3.3V to 2.5V of the working voltage signal Vwork, so there exists a voltage reduction of 0.8V which dissipates in a form of heat. Therefore, the power loss therein is 1-2.5V/3.3V=25%. However, in the prior art using 5V as the input voltage, there exists a heat dissipation due to the voltage reduction of 2.5V, so the power loss in the prior art is 1-2.5V/5V=50%. On the other hand, suppose the voltage value of the working voltage signal Vwork is greater than 3.3V, the voltage selection circuit 10 chooses the second voltage signal V2 as the output voltage signal Vout. The following Table 1 illustrates the energy loss in accordance with the prior art and the energy loss in accordance with the present invention under different working voltages.

TABLE 1

| Working | | Heat Loss | Heat Loss |
|---|---|---|---|
| Voltage | | (Prior Art) | (Present Invention) |
| 2.5 | V | 1-2.5 V/5 V = 50% | 1-2.5 V/3.3 V = 25% |
| 3 | V | 1-3 V/5 V = 40% | 1-3 V/3.3 V = 10% |
| 4 | V | 1-4 V/5 V = 20% | 1-4 V/5 V = 20% |
| 5 | V | 1-5 V/5 V = 0% | 1-5 V/5 V = 0% |

From the above-illustrated data, it can be seen that power losses in the power control system using dual or multiple power sources can be lowered; in other words, it is possible to improve the power conversion efficiency thereby achieving the objective of energy saving and carbon reduction.

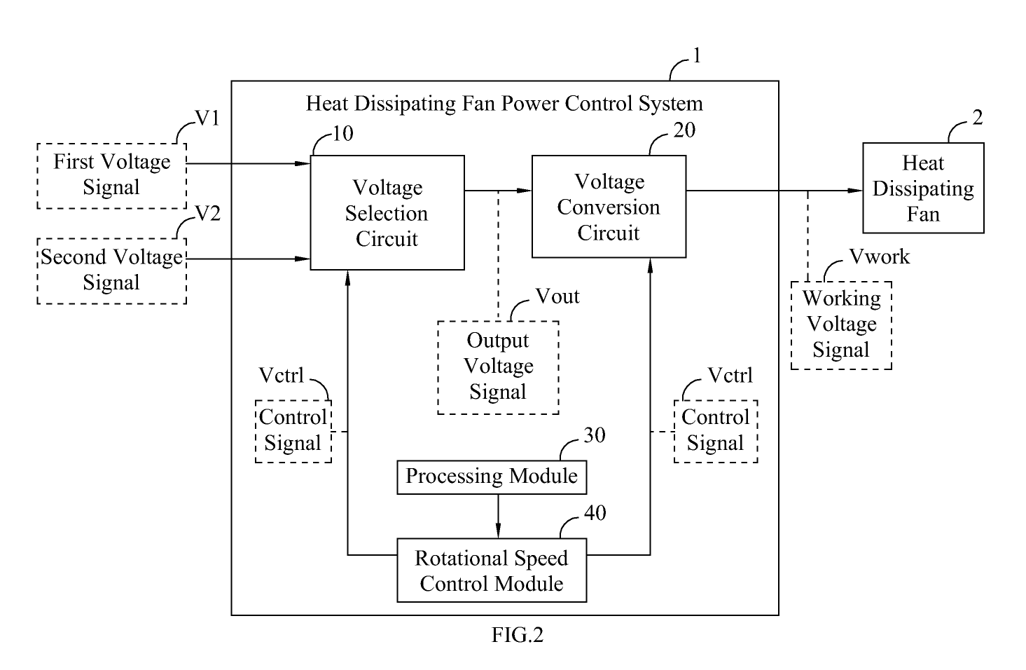

Refer next to FIG. 2, wherein a block diagram for a second embodiment of the heat dissipating fan power control system according to the present invention is shown. Compared with the first embodiment as mentioned, the differences therein between lie in that, for the second embodiment, it further comprises a processing module 30 and a rotational speed control module 40, and the voltage selection circuit 10 is allowed to choose between two voltages, the first voltage signal V1 and the second voltage signal V2. While the rest portions in both embodiments are identical, descriptions thereof are omitted for brevity.

The processing module 30 is connected to the rotational speed control module 40 and able to control the rotational speed control module 40 to generate a control signal Vctrl according to the temperature in a target (not shown) to which the heat dissipating fan 2 is applied for the purpose of heat dissipation; or alternatively, based on the rotational speed of the heat dissipating fan 2 selected by a user, the rotational speed control module 40 can also accordingly generate a corresponding control signal Vctrl.

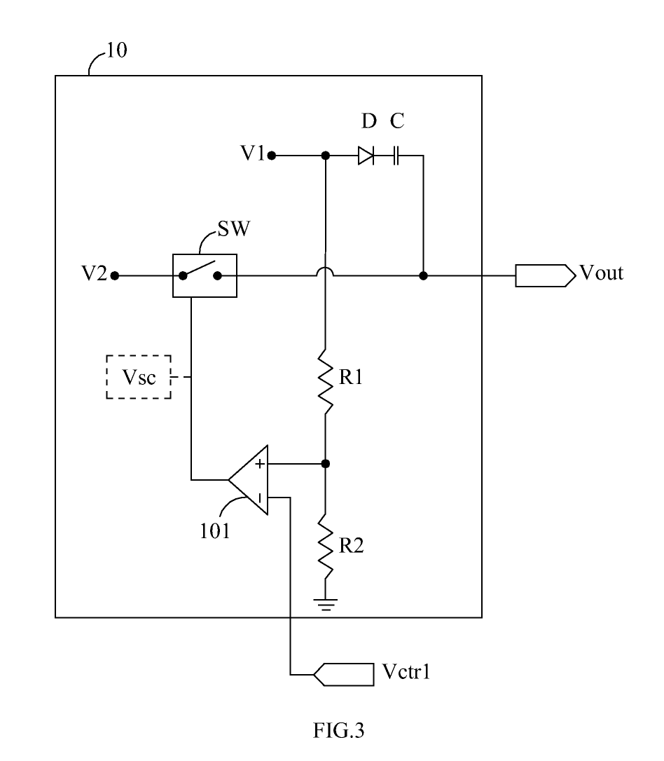

Refer now to FIG. 3, wherein a circuit diagram for the voltage selection circuit illustrated in the second embodiment of the heat dissipating fan power control system according to the present invention is shown. In the figure, the voltage selection circuit 10 comprises a comparator 101, a switch SW, a first resistor R1, a second resistor R2, a diode D and a capacitor C. The couplings for respective components in the voltage selection circuit 10 are depicted as shown in the figure and herein omitted for brevity.

After voltage division by means of the first resistor R1 and the second resistor R2, the first voltage signal V1 is inputted into the positive input end of the comparator 101, while the control signal Vctrl is inputted into the negative input end of the comparator 101, where the voltage selection circuit 10 compares such two voltage values and outputs accordingly a switch control signal Vsc to the switch SW to control the conductivity or cutoff therein. The switch signal is preferably a p-typed MOSFET. In case the voltage value of the control signal Vctrl is smaller than the voltage-divided first voltage signal V1, the comparator 101 outputs a switch control signal Vsc of high level; contrarily. When the voltage value of the control signal Vctrl is greater than the voltage-divided first voltage signal V1, it outputs a switch control signal Vsc of low level. Thereby, the switch SW can be effectively controlled via such a high or low level in the switch control signal Vsc.

When the switch SW is OFF, the first voltage signal V1 is used as the output voltage signal Vout and outputted to the voltage conversion circuit 20. On the other hand, suppose the switch SW is conductive, since the voltage value of the second voltage signal V2 is greater than the one of the first voltage signal V1, the diode D is cutoff, so the second voltage signal V2 is used as the output voltage signal Vout and outputted to the voltage conversion circuit 20.

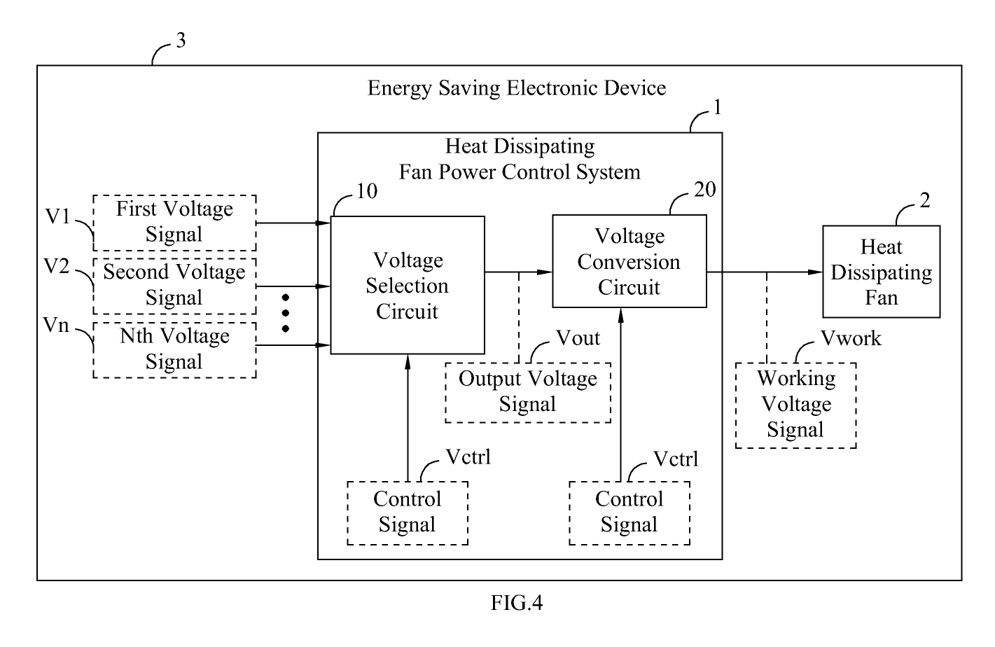

Refer subsequently to FIG. 4, wherein a block diagram for the energy saving electronic device according to the present invention is shown. In the figure, the energy saving electronic device 3 comprises a heat dissipating fan 2 and a heat dissipating fan power control system 1.

The heat dissipating fan power control system 1 is connected to the heat dissipating fan 2, and the heat dissipating fan 2 comprises a voltage selection circuit 10 and a voltage conversion circuit 20. The voltage selection circuit 10 receives a plurality of voltage signals provided by a plurality of voltage input ends and a control signal Vctrl, and selects one of the plurality of voltage signals as the output voltage signal Vout based on the control signal Vctrl.

The voltage conversion circuit 20 is connected between the voltage selection circuit 10 and the heat dissipating fan 2, and receives the selected output voltage signal Vout and the control signal Vctrl. The voltage conversion circuit 20 then converts the voltage value of the output voltage signal Vout into the voltage value of the working voltage signal Vwork required by the heat dissipating fan 2 according to the control signal Vctrl.

Herein, the output voltage signal Vout is selected from the plurality of voltage signals such that the voltage value thereof is greater than and closest to the working voltage value.

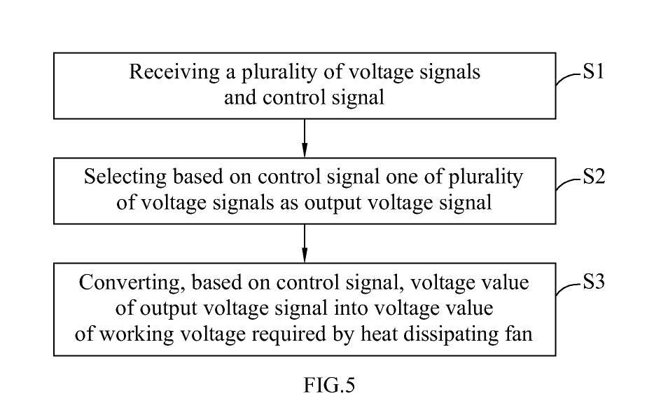

Refer finally to FIG. 5, wherein a flowchart for the heat dissipating fan power control method according to the present invention is shown. The present heat dissipating fan power control method is suitable for providing the heat dissipating fan 2 with the required working voltage. The heat dissipating fan power control method comprises the following steps:

In Step S1, a plurality of voltage signals and a control signal are received by a voltage selection circuit. The output voltage signal is selected from the plurality of voltage signals such that the voltage value thereof is greater than and closest to the working voltage value.

In Step S2, one of the plurality of voltage signals is selected as an output voltage signal by the voltage selection circuit according to the control signal.

In Step S3, the selected output voltage signal and the control signal are received by a voltage conversion circuit, and the voltage value of the output voltage signal is converted into the voltage value of the working voltage signal according to the control signal, thereby driving the heat dissipating fan.

What is claimed is:

1. A heat dissipating fan power control system for providing a working voltage signal required by a heat dissipating fan, the working voltage signal having a working voltage value, the heat dissipating fan power control system comprising:
a voltage selection circuit arranged for receiving a plurality of voltage signals and a control signal, the plurality of voltage signals being provided by a plurality of voltage input ends, and the voltage selection circuit selecting one of the plurality of voltage signals as an output voltage signal according to the control signal; and
a voltage conversion circuit connected to the voltage selection circuit, the voltage conversion circuit receiving the output voltage signal and the control signal, and converting voltage value of the output voltage signal into the working voltage value according to the control signal thereby driving the heat dissipating fan;
wherein the output voltage signal is selected from the plurality of voltage signals such that the voltage value thereof is greater than and closest to the working voltage value.

2. The heat dissipating fan power control system according to claim 1, further comprising a processing module generating the control signal according to the temperature of a target to which the heat dissipating fan is applied for heat dissipation.

3. The heat dissipating fan power control system according to claim 1, wherein the heat dissipating fan is further connected to a rotational speed selection module to select a rotational speed of the heat dissipating fan, thereby allowing the rotational speed selection module to generate the control signal.

4. The heat dissipating fan power control system according to claim 1, wherein the plurality of voltage signals comprise a first input voltage and a second input voltage, and the voltage selection circuit further comprises a comparator and a switch, the comparator compares the control signal with the first voltage signal, then outputs a switch control signal to the switch such that the voltage selection circuit selects either the first voltage signal or the second voltage signal as the output voltage signal.

5. The heat dissipating fan power control system according to claim 4, wherein the switch is a transistor.

6. The heat dissipating fan power control system according to claim 1, wherein the voltage values of the voltage signals are different from one another.

7. The heat dissipating fan power control system according to claim 1, wherein the voltage conversion circuit is a voltage reduction circuit.

8. An energy saving electronic device comprising:
a heat dissipating fan being driven by a working voltage; and
a heat dissipating fan power control system connected to the heat dissipating fan, the heat dissipating fan power control system comprising:
a voltage selection circuit arranged for receiving a plurality of voltage signals and a control signal, the plurality of voltage signals being provided by a plurality of voltage input ends, and the voltage selection circuit selecting one of the plurality of voltage signals as an output voltage signal according to the control signal; and
a voltage conversion circuit connected between the voltage selection circuit and the heat dissipating fan, the voltage conversion circuit receiving the output voltage signal and the control signal, and converting voltage value of the output voltage signal into the working voltage value according to the control signal thereby driving the heat dissipating fan;
wherein the output voltage value is selected from the plurality of voltage signals such that the voltage value thereof is greater than and closest to the working voltage value.

9. The energy saving electronic device according to claim 8, further comprising a processing module generating the control signal according to the temperature of a target to which the heat dissipating fan is applied for heat dissipation.

10. The energy saving electronic device according to claim 8, wherein the heat dissipating fan is further connected to a rotational speed selection module to select a rotational speed of the heat dissipating fan, thereby allowing the rotational speed selection module to generate the control signal.

11. The energy saving electronic device according to claim 8, wherein the plurality of voltage signals comprise a first input voltage and a second input voltage, and the voltage selection circuit further comprises a comparator and a switch, the comparator compares the control signal with the first voltage signal, then outputs a switch control signal to the switch such that the voltage selection circuit selects either the first voltage signal or the second voltage signal as the output voltage signal.

12. The energy saving electronic device according to claim 8, wherein the voltage values of the voltage signals are different from one another.

13. The energy saving electronic device according to claim 8, wherein the voltage conversion circuit is a voltage reduction circuit.

14. A heat dissipating fan power control method for providing a working voltage signal required by a heat dissipating fan, the working voltage signal having a working voltage value, the heat dissipating fan power control method comprising the following steps:
receiving, through a voltage selection circuit, a plurality of voltage signals provided by a plurality of voltage input ends and a control signal;
selecting, through the voltage selection circuit, one of the plurality of voltage signals as an output voltage signal according to the control signal; and
receiving, through a voltage conversion circuit, the selected output voltage signal and the control signal, and converting voltage value of the output voltage signal into the working voltage value according to the control signal thereby driving the heat dissipating fan;
wherein the output voltage signal is selected from the plurality of voltage signals such that the voltage value thereof is greater than and closest to the working voltage value.

15. The heat dissipating fan power control method according to claim 14, further comprising providing a processing module, the processing module generating the control signal according to the temperature of a target to which the heat dissipating fan is applied for heat dissipation.

16. The heat dissipating fan power control method according to claim 14, further comprising providing a rotational speed selection module to select a rotational speed of the heat dissipating fan and to generate the control signal accordingly.

17. The heat dissipating fan power control method according to claim 14, wherein the plurality of voltage signals comprise a first input voltage and a second input voltage, and the voltage selection circuit further comprises a comparator and a switch, the comparator compares the control signal with the first voltage signal, then outputs a switch control signal to the switch such that the voltage selection circuit selects either the first voltage signal or the second voltage signal as the output voltage signal.

18. The heat dissipating fan power control method according to claim 17, wherein the switch is a transistor.

19. The heat dissipating fan power control method according to claim 14, wherein the voltage values of the voltage signals are different from one another.

20. The heat dissipating fan power control method according to claim 14, wherein the voltage conversion circuit is a voltage reduction circuit.
